(19) United States
(12) Patent Application Publication
(10) Pub. No.: US 2015/0293977 A1
(43) Pub. Date: Oct. 15, 2015

(54) INTERACTIVE SEARCH RESULTS

(71) Applicant: Yahoo! Inc., Sunnyvale, CA (US)

(72) Inventors: Sophia Thitirat Perl, San Jose, CA (US); Andrew Poon, San Francisco, CA (US); Enrique Andres Munoz Torres, Mountain View, CA (US); Tingyi Wu, Sunnyvale, CA (US); Conrad Wai, San Francisco, CA (US)

(73) Assignee: Yahoo! Inc., Sunnvale, CA (US)

(21) Appl. No.: 14/253,613

(22) Filed: Apr. 15, 2014

(51) Int. Cl. G06F 17/30; G06Q 30/02

(52) U.S. Cl. CPC G06F 17/30554; G06Q 30/0256; G06Q 30/0273; G06F 17/30477

(57) ABSTRACT

Based on a user's search query, a search result (such as a sponsored search result) can appear within a graphical user interface (GUI) of a client-side application, and the client-side application can provide a mechanism for user interaction with the search result. The GUI of the client-side application can be a page view of a web browser. The mechanism of the client-side application can occur within the same page view as the search result. For example, the mechanism can include a sub-GUI that extends out from the search result on the same page view as the search result. Also, the search result and/or the sub-GUI can be monetized.

### BACKGROUND

This application relates to user interaction with online search results, such as sponsored search results. This application also relates to monetization of search results.

Search engine marketing (SEM) can include promotion of products and services. For example, SEM can include promotion of online products and services, such as websites. SEM can promote products and services by increasing their visibility in search engine results via advertising and optimization. One way to optimize search results is to target users with regard to particular search results. Also, SEM may use search engine optimization (SEO) that can adjust website content to achieve higher visibility of an ad or link. For example, users can be targeted for certain links and ads to appear on a page that was searched.

In SEM, advertiser's links and content, including search results, can be monetized. Monetization can occur in various ways and can optimize SEM as well. Monetization can also be optimized to maximize revenue generation for advertisers and SEM service providers, such as Yahoo! Inc. For example, SEM service providers can adjust pricing for clicks on an advertiser's ad by a click through rate for that ad. Such adjustments can benefit the provider and the advertiser.

### BRIEF DESCRIPTION OF THE DRAWINGS

The systems and methods may be better understood with reference to the following drawings and description. Non-limiting and non-exhaustive examples are described with reference to the following drawings. The components in the drawings are not necessarily to scale; emphasis instead is being placed upon illustrating the principles of the system. In the drawings, like referenced numerals designate corresponding parts throughout the different views.

FIG. 1 illustrates a block diagram of an example information system that includes example devices of a network that can provide interactive search results, such as interactive sponsored search results.

FIGS. 2-5 illustrate displayed search results, including non-sponsored search results and sponsored search results, on example page views rendered by a client-side application, such a web browser. Such a client-side application can be executed on any one of the client devices illustrated in FIG. 1.

FIG. 6 illustrates a block diagram of example circuitry of a client device of an example system that can provide interactive search results, such as the system illustrated in FIG. 1.

FIGS. 7 and 8 are block diagrams of example electronic devices that can implement aspects of and are related to the example system that can provide interactive search results. For example, FIG. 7 illustrates an example of the audience client device 124 in FIG. 1; and FIG. 8 illustrates an example of the search engine server 106 and/or the sponsored search server 116 in FIG. 1.

### DETAILED DESCRIPTION

Subject matter will now be described more fully hereinafter with reference to the accompanying drawings, which form a part hereof, and which show, by way of illustration, specific examples. Subject matter may, however, can be embodied in a variety of different forms and, therefore, covered or claimed subject matter is intended to be construed as not being limited to examples set forth herein; examples are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

### Overview of Interactive Search Results

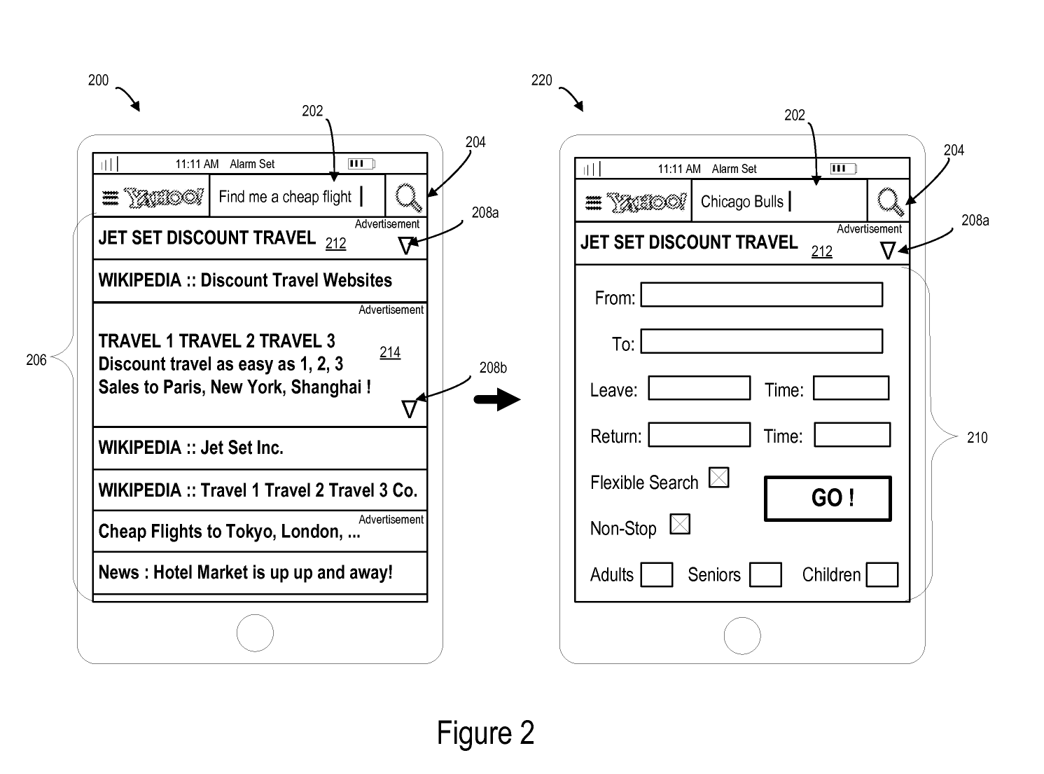

Based on a user's search query, a search result (such as a sponsored search result) can appear within a graphical user interface (GUI) of a client-side application. The client-side application can then provide a mechanism for user interaction with the search result. A sponsored search result can be a sold or a donated advertisement in the form of a search result. Usually, a sponsored search result will include an identification that the search result is a sold or a donated advertisement, such as the identification “Advertisement” in example search results 212 and 214 of FIG. 2. The GUI of the client-side application can be a page view displayed by a web browser. The mechanism of the client-side application can occur within the same page view as the search result. For example, the mechanism can include a sub-GUI that extends out from the search result on the same page view as the search result.

The sub-GUI can be encompassed by a dialog bubble that extends from the search result. Alternatively, the area of the page view that contains the search result can be increased to accommodate the sub-GUI. For example, the area encompassing the search result can extend downward to provide enough space for the sub-GUI. Also, the sub-GUI can be a form associated with the search result. For example, the search result can be a sponsored search result for an advertiser advertising a product or a service, and a respective sub-GUI that extends from the search result can be a form that allows a user to order the product or the service.

Many other examples of the mechanism can be executed. For example, in one case, the sub-GUI associated with the search result can take up the entire page view or at least a majority of the page view. This last example and other examples can bring the sub-GUI to the forefront of the page view and/or suppress other content on the page view to emphasize the sub-GUI. Besides the structure of the sub-GUI, the sub-GUI can provide various interactive experiences for the user. For example, besides a form, the sub-GUI can be a video game or any other type of interactive content. Additionally, information regarding interactions with such a sub-GUI can be used to optimize future renderings of the sub-GUI.

Furthermore, interactions with aspects of the sub-GUI can be monetized. In the case of a sponsored search result having such a sub-GUI, not only can the sponsored search result be monetized, but also aspects of the sub-GUI can be monetized as well.

Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking. Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties. Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot markets, for example. In various models, advertisers may pay based at least in part on any of various metrics associated with advertisement delivery or performance, or associated with measurement or approximation of particular advertiser goals. For example, models may include, among other things, payment based at least in part on cost per impression or number of impressions, cost per click or number of clicks, cost per action for some specified actions, cost per conversion or purchase, or cost based at least in part on some combination of metrics, which may include online or offline metrics, for example.

In some examples, a system, product, or method that can provide for in-depth user interactions with search results can include circuitry of a client device configured to: receive a search query from a search field, communicate the search query to a search server, and receive a search result, such as a sponsored search result, from the search server according to the search query. Also, the circuitry can be configured to display the search result on a page view, and display a GUI associated with the search result on the same page view. The circuitry can also be configured to receive a user input from a user input field of the GUI, and initiate an action according to the user input, such as initiating displaying audio content, video content, textual content, graphical content, tactile content, and/or any other type of human perceivable content within the same GUI and/or another part of the same page view.

### DESCRIPTION OF THE DRAWINGS

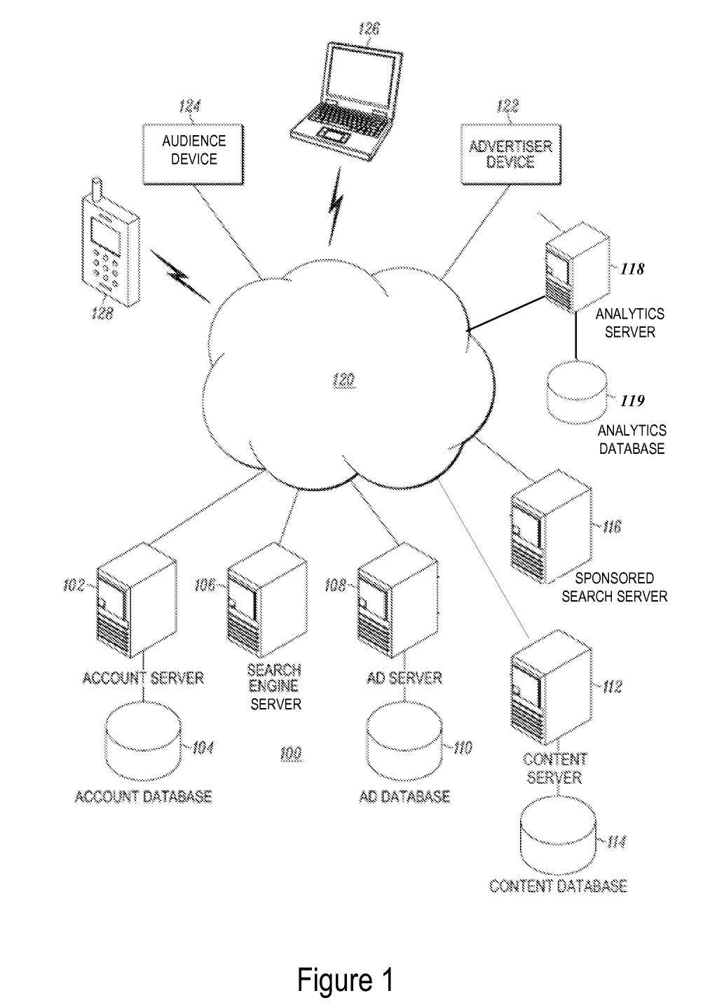

FIG. 1 illustrates a block diagram of an example information system that includes example devices of a network that can provide interactive search results, such as interactive sponsored search results. The information system 100 in the example of FIG. 1 includes an account server 102, an account database 104, a search engine server 106, an ad server 108, an ad database 110, a content database 114, a content server 112, a sponsored search server 116 (which can also be communicatively coupled with a corresponding database), an analytics server 118, and an analytics database 119. The aforementioned servers and databases can be communicatively coupled over a network 120.

The information system 100 may be accessible over the network 120 by advertiser devices, such as an advertiser client device 122 and by audience devices, such as an audience client device 124. An audience device can be a client device that presents online content, such as search results and advertisements, to a user. In various examples of such an online information system, users may search for and obtain content from sources over the network 120, such as obtaining content from the search engine server 106, the ad server 108, the ad database 110, the content server 112, and the content database 114. Advertisers may provide advertisements for placement on electronic properties, such as web pages, and other communications sent over the network to audience devices, such as the audience client device 124. The online information system can be deployed and operated by an online services provider, such as Yahoo! Inc.

The account server 102 stores account information for advertisers. The account server 102 is in data communication with the account database 104. Account information may include database records associated with each respective advertiser. Suitable information may be stored, maintained, updated and read from the account database 104 by the account server 102. Examples include advertiser identification information, advertiser security information, such as passwords and other security credentials, account balance information, and information related to content associated with their ads, and user interactions associated with their ads and associated content. Also, examples include analytics data related to their ads and associated content and user interactions with the aforementioned. In an example, the analytics data may be in the form of one or more sketches, such as in the form of a sketch per audience segment, segment combination, or at least part of a campaign. The account information may include ad booking information. This booking information can be used as input for determining ad impression availability.

The account server 102 may be implemented using a suitable device. The account server 102 may be implemented as a single server, a plurality of servers, or another type of computing device known in the art. Access to the account server 102 can be accomplished through a firewall that protects the account management programs and the account information from external tampering. Additional security may be provided via enhancements to the standard communications protocols, such as Secure HTTP (HTTPS) or the Secure Sockets Layer (SSL). Such security may be applied to any of the servers of FIG. 1, for example.

The account server 102 may provide an advertiser front end to simplify the process of accessing the account information of an advertiser (such as a client-side application). The advertiser front end may be a program, application, or software routine that forms a user interface. In a particular example, the advertiser front end is accessible as a website with electronic properties that an accessing advertiser may view on an advertiser device, such as the advertiser client device 122. The advertiser may view and edit account data and advertisement data, such as ad booking data, using the advertiser front end. After editing the advertising data, the account data may then be saved to the account database 104.

Also, audience analytics, impressions delivered, impression availability, and segments may be viewed in real time using the advertiser front end. The advertiser front end may be a client-side application, such as a client-side application running on the advertiser client device. A script and/or applet (such as a script and/or applet) may be a part of this front end and may render access points for retrieval of the audience analytics, impressions delivered, impression availability, and segments. In an example, this front end may include a graphical display of fields for selecting an audience segment, segment combination, or at least part of a campaign. The front end, via the script and/or applet, can request the audience analytics, impressions delivered, and impression availability for the audience segment, segment combination, or at least part of a campaign. The information can then be displayed, such as displayed according to the script and/or applet.

The search engine server 106 may be one or more servers. Alternatively, the search engine server 106 may be a computer program, instructions, or software code stored on a computer-readable storage medium that runs on one or more processors of one or more servers. The search engine server 106 may be accessed by audience devices, such as the audience client device 124 operated by an audience member over the network 120. Access may be through graphical access points. For example, query entry box (such as query entry box 202, 302, or 402 of FIGS. 2, 3, and 4, respectively) may be an access point for the user to submit a search query to the search engine server 106, from the audience client device 124. Search queries submitted or other user interactions with the search engine server 106 can be logged in data logs, and such logs may be communicated to the analytics server 118 for processing. After processing, the analytics server 118 can output corresponding analytics data to be served to the search engine server 106 or the sponsored search server 116 for determining non-sponsored search results, sponsored search results, and other types of ad impressions.

Besides a search query, the audience client device 124 can communicate interactions with a search result, such as interactions with a sub-GUI associated with the search result appearing on the same page view as the search result. Such interactions can be communicated to the search engine server 106, the sponsored search engine server 116, and/or the analytics server 118, for example. The search engine server 106 and the sponsored search engine server 116 locate matching information using a suitable protocol or algorithm and returns information to the audience client device 124, such as in the form of ads or search results. The search engine server 106 and the sponsored search engine server 116 may receive the user interaction information, that can include search queries, from an audience device, and send corresponding information to the ad server 108 and/or the content server 112, and the ad server 108 and/or the content server 112 may serve corresponding ads and/or search results, but with more in-depth details or an accompanying sub-GUI for interacting with subject matter associated with ads or search results. The information inputted and/or outputted by these devices may be logged in data logs and communicated to the analytics server 118 for processing, via the network 120. The analytics server 118 can provide analyzed feedback for affecting future serving of content, such as serving of smarter ads and search results.

The search engine server 106 may be designed to help users and potential audience members find information located on the Internet or an intranet. In an example, the search engine server 106 may also provide to the audience client device 124 over the network 120 an electronic property, such as a web page, with content, including search results, information matching the context of a user inquiry, links to other network destinations, or information and files of information of interest to a user operating the audience client device 124, as well as a stream or web page of content items and advertisement items selected for display to the user. This information provided by the search engine server 106 may also be logged, and such logs may be communicated to the analytics server 118 for processing. Once processed into corresponding analytics data, such data can be input for improving ad and search result delivery, including delivery of the associated sub-GUIs.

The search engine server 106 may enable a device, such as the advertiser client device 122, the audience client device 124, or another type of client device, to search for files of interest using a search query. Typically, the search engine server 106 may be accessed by a client device via servers or directly over the network 120. The search engine server 106 may include a crawler component, an indexer component, an index storage component, a search component, a ranking component, a cache, a profile storage component, a logon component, a profile builder, and application program interfaces (APIs). The search engine server 106 may be deployed in a distributed manner, such as via a set of distributed servers, for example. Components may be duplicated within a network, such as for redundancy or better access.

The ad server 108 operates to serve advertisements to audience devices, such as the audience client device 124. An advertisement may include text data, graphic data, image data, video data, or audio data. Advertisements may also include data defining advertisement information that may be of interest to a user of an audience device. The advertisements may also include respective audience targeting information or ad campaign information, such as information on audience segments and segment combinations. An advertisement may further include data defining links to other online properties reachable through the network 120. The aforementioned audience targeting information and the other data associated with an ad may be logged in data logs and such logs may be communicated to the analytics server 118 for processing. Once processed into corresponding analytics data, such data can be used as feedback to further optimize search engine results and ads, and even a sub-GUI that can extend from a search result and/or the ad on the same page view as the search result or the ad.

For online service providers, advertisements may be displayed on electronic properties resulting from a user-defined search based, at least in part, upon search terms. Advertising may be beneficial to users, advertisers or web portals if displayed advertisements are relevant to audience segments, segment combinations, or at least parts of campaigns. Thus, a variety of techniques have been developed to determine corresponding audience segments or to subsequently target relevant advertising to audience members of such segments. For example user interests, user intentions, and targeting data related to segments or campaigns may be may be logged in data logs and such logs may be communicated to the analytics server 118 for processing. Once processed into corresponding analytics data, such data can be used as feedback to further optimize search engine results and ads, and even a sub-GUI that can extend from a search result and/or the ad on the same page view as the search result or the ad.

One approach to presenting targeted advertisements includes employing demographic characteristics (such as age, income, sex, occupation, etc.) for predicting user behavior, such as by group. Advertisements may be presented to users in a targeted audience based, at least in part, upon predicted user behavior. The aforementioned targeting data, such as demographic data and psychographic data, may be logged in data logs and such logs may be communicated to the analytics server 118 for processing. Once processed into corresponding analytics data, such data can be used as feedback to further optimize search engine results and ads, and even a sub-GUI that can extend from a search result and/or the ad on the same page view as the search result or the ad.

Another approach includes profile-type ad targeting. In this approach, user profiles specific to a user may be generated to model user behavior, for example, by tracking a user's path through a website or network of sites, and compiling a profile based, at least in part, on pages or advertisements ultimately delivered. A correlation may be identified, such as for user purchases, for example. An identified correlation may be used to target potential purchasers by targeting content or advertisements to particular users. The aforementioned profile-type targeting data may be logged in data logs and such logs may be communicated to the analytics server 118 for processing. Once processed into corresponding analytics data, such data can be used as feedback to further optimize search engine results and ads, and even a sub-GUI that can extend from a search result and/or the ad on the same page view as the search result or the ad.

Yet another approach includes targeting based on content of an electronic property requested by a user. Advertisements may be placed on an electronic property or in association with other content that is related to the subject of the advertisements. The relationship between the content and the advertisement may be determined in a suitable manner. The overall theme of a particular electronic property may be ascertained, for example, by analyzing the content presented therein. Moreover, techniques have been developed for displaying advertisements geared to the particular section of the article currently being viewed by the user. Accordingly, an advertisement may be selected by matching keywords, and/or phrases within the advertisement and the electronic property. The aforementioned targeting data may be logged in data logs and such logs may be communicated to the analytics server 118 for processing. Once processed into corresponding analytics data, such data can be used as feedback to further optimize search engine results and ads, and even a sub-GUI that can extend from a search result and/or the ad on the same page view as the search result or the ad.

The ad server 108 includes logic and data operative to format the advertisement data for communication to a user device, such as an audience member device. The ad server 108 is in data communication with the ad database 110. The ad database 110 stores information, including data defining advertisements, to be served to user devices. This advertisement data may be stored in the ad database 110 by another data processing device or by an advertiser. The advertising data may include data defining advertisement creatives and bid amounts for respective advertisements and/or audience segments. The aforementioned ad formatting and pricing data may be logged in data logs and such logs may be communicated to the analytics server 118 for processing. Once processed into corresponding analytics data, such data can be used as feedback to further optimize search engine results and ads, and even a sub-GUI that can extend from a search result and/or the ad on the same page view as the search result or the ad.

The advertising data may be formatted to an advertising item that may be included in a stream of content items and advertising items provided to an audience device. The formatted advertising items can be specified by appearance, size, shape, text formatting, graphics formatting and included information, which may be standardized to provide a consistent look for advertising items in the stream. The aforementioned advertising data may be logged in data logs and such logs may be communicated to the analytics server 118 for processing. Once processed into corresponding analytics data, such data can be used as feedback to further optimize search engine results and ads, and even a sub-GUI that can extend from a search result and/or the ad on the same page view as the search result or the ad.

Further, the ad server 108 is in data communication with the network 120. The ad server 108 communicates ad data and other information to devices over the network 120. This information may include advertisement data communicated to an audience device. This information may also include advertisement data and other information communicated with an advertiser device, such as the advertiser client device 122. An advertiser operating an advertiser device may access the ad server 108 over the network to access information, including advertisement data. This access may include developing advertisement creatives, editing advertisement data, deleting advertisement data, setting and adjusting bid amounts and other activities. The ad server 108 then provides the ad items to other network devices, such as the sponsored search server 116, the analytics server 118, and/or the account server 102, for classification of the ad items (such as associating the ad items with audience segments, segment combinations, or at least parts of campaigns). This information can be used to further optimize search engine results and ads, and even a sub-GUI that can extend from a search result and/or the ad on the same page view as the search result or the ad.

The ad server 108 may provide an advertiser front end to simplify the process of accessing the advertising data of an advertiser. The advertiser front end may be a program, application or software routine that forms a user interface. In one particular example, the advertiser front end is accessible as a website with electronic properties that an accessing advertiser may view on the advertiser device. The advertiser may view and edit advertising data using the advertiser front end. After editing the advertising data, the advertising data may then be saved to the ad database 110 for subsequent communication in advertisements to an audience device.

The ad server 108, the content server 112, or any other server described herein may be one or more servers. Alternatively, the ad server 108, the content server 112, or any other server described herein may be a computer program, instructions, and/or software code stored on a computer-readable storage medium that runs on one or more processors of one or more servers. The ad server 108 may access information about ad items either from the ad database 110 or from another location accessible over the network 120. The ad server 108 communicates data defining ad items and other information to devices over the network 120. The content server 112 may access information about content items either from the content database 114 or from another location accessible over the network 120. The content server 112 communicates data defining content items and other information to devices over the network 120. Content items and the ad items may include any form of content included in a sub-GUI that extends from a search result and/or an ad, on the same page view as the search result or ad.

The information about content items may also include content data and other information communicated by a content provider operating a content provider device, such as respective audience segment information. A content provider operating a content provider device may access the content server 112 over the network 120 to access information, including the respective segment information. This access may be for developing content items, editing content items, deleting content items, setting and adjusting bid amounts and other activities, such as associating content items with audience segments, segment combinations, or at least parts of campaigns. A content provider operating a content provider device may also access the analytics server 118 over the network 120 to access analytics data. Such analytics may help focus developing content items, editing content items, deleting content items, setting and adjusting bid amounts, and activities related to distribution of the content.

The content server 112 may provide a content provider front end to simplify the process of accessing the content data of a content provider. The content provider front end may be a program, application or software routine that forms a user interface. In a particular example, the content provider front end is accessible as a website with electronic properties that an accessing content provider may view on the content provider device. The content provider may view and edit content data using the content provider front end. After editing the content data, such as at the content server 112 or another source of content, the content data may then be saved to the content database 114 for subsequent communication to other devices in the network 120.

The content provider front end may be a client-side application, such as a client-side application running on the advertiser client device or the audience client device, respectively. A script and/or applet, such as the script and/or applet, may be a part of this front end and may render access points for retrieval of impression availability data (such as the impression availability data), and the script and/or applet may manage the retrieval of the impression availability data. In an example, this front end may include a graphical display of fields for selecting audience segments, segment combinations, or at least parts of campaigns. Then this front end, via the script and/or applet, can request the impression availability for the audience segments, segment combinations, or at least parts of campaigns. The analytics can then be displayed, such as displayed according to the script and/or applet.

The content server 112 includes logic and data operative to format content data for communication to the audience device. The content server 112 can provide content items or links to such items to the analytics server 118 or the availability server to associate with audience segments and impression availability data. For example, content items and links may be matched to such data. The matching may be complex and may be based on historical information related to the audience segments and impression availability. Techniques for matching content items and links to the audience segments are numerous and beyond the scope of this application.

The content data may be formatted to a content item that may be included in a stream of content items and advertisement items provided to an audience device. The formatted content items can be specified by appearance, size, shape, text formatting, graphics formatting and included information, which may be standardized to provide a consistent look for content items in the stream. The formatting of content data may be logged in data logs and such logs may be communicated to the analytics server 118 for processing. Once processed into corresponding analytics data, such data can be used as feedback to further optimize search engine results and ads, and even a sub-GUI that can extend from a search result and/or the ad on the same page view as the search result or the ad.

In an example, the content items may have an associated bid amount that may be used for ranking or positioning the content items in a stream of items presented to an audience device. In other examples, the content items do not include a bid amount, or the bid amount is not used for ranking the content items. Such content items may be considered non-revenue generating items. The bid amounts and other related information may be logged in data logs and such logs may be communicated to the analytics server 118 for processing. Once processed into corresponding analytics data, such data can be used as feedback to further optimize search engine results and ads, and even a sub-GUI that can extend from a search result and/or the ad on the same page view as the search result or the ad.

The aforementioned servers and databases may be implemented through a computing device. A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally, a server may include a central processing unit and memory. A server may also include a mass storage device, a power supply, wired and wireless network interfaces, input/output interfaces, and/or an operating system, such as Windows Server, Mac OS X, UNIX, Linux, FreeBSD, or the like.

The aforementioned servers and databases may be implemented as online server systems or may be in communication with online server systems. An online server system may include a device that includes a configuration to provide data via a network to another device including in response to received requests for page views or other forms of content delivery. An online server system may, for example, host a site, such as a social networking site, examples of which may include, without limitation, Flicker, Twitter, Facebook, LinkedIn, or a personal user site (such as a blog, vlog, online dating site, etc.). An online server system may also host a variety of other sites, including, but not limited to business sites, educational sites, dictionary sites, encyclopedia sites, wikis, financial sites, government sites, etc.

An online server system may further provide a variety of services that may include web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as an online server system include desktop computers, multiprocessor systems, microprocessor-type or programmable consumer electronics, etc. The online server system may or may not be under common ownership or control with the servers and databases described herein.

The network 120 may include a data communication network or a combination of networks. A network may couple devices so that communications may be exchanged, such as between a server and a client device or other types of devices, including between wireless devices coupled via a wireless network, for example. A network may also include mass storage, such as a network attached storage (NAS), a storage area network (SAN), or other forms of computer or machine readable media, for example. A network may include the Internet, local area networks (LANs), wide area networks (WANs), wire-line type connections, wireless type connections, or any combination thereof. Likewise, sub-networks, may employ differing architectures or may be compliant or compatible with differing protocols, and may interoperate within a larger network, such as the network 120.

Various types of devices may be made available to provide an interoperable capability for differing architectures or protocols. For example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links, including satellite links, or other communication links or channels, such as may be known to those skilled in the art. Furthermore, a computing device or other related electronic devices may be remotely coupled to a network, such as via a telephone line or link, for example.

The advertiser client device 122 includes a data processing device that may access the information system 100 over the network 120. The advertiser client device 122 is operative to interact over the network 120 with any of the servers or databases described herein. The advertiser client device 122 may implement a client-side application for viewing electronic properties and submitting user requests. The advertiser client device 122 may communicate data to the information system 100, including data defining electronic properties and other information. The advertiser client device 122 may receive communications from the information system 100, including data defining electronic properties and advertising creatives. The aforementioned interactions and information may be logged in data logs and such logs may be communicated to the analytics server 118 for processing. Once processed into corresponding analytics data, such data can be used as feedback to further optimize search engine results and ads, and even a sub-GUI that can extend from a search result and/or the ad on the same page view as the search result or the ad.

In an example, content providers may access the information system 100 with content provider devices that are generally analogous to the advertiser devices in structure and function. The content provider devices provide access to content data in the content database 114, for example.

The audience client device 124 includes a data processing device that may access the information system 100 over the network 120. The audience client device 124 is operative to interact over the network 120 with the search engine server 106, the ad server 108, the content server 112, and the analytics server 118. The audience client device 124 may implement a client-side application for viewing electronic content and submitting user requests. A user operating the audience client device 124 may enter a search request and communicate the search request to the information system 100. The search request is processed by the search engine and search results are returned to the audience client device 124. The aforementioned interactions and information may be logged in data logs and such logs may be communicated to the analytics server 118 for processing. Once processed into corresponding analytics data, such data can be used as feedback to further optimize search engine results and ads, and even a sub-GUI that can extend from a search result and/or the ad on the same page view as the search result or the ad.

In other examples, a user of the audience client device 124 may request data, such as a page of information from the online information system 100. The data instead may be provided in another environment, such as a native mobile application, TV application, or an audio application. The online information system 100 may provide the data or re-direct the browser to another source of the data. In addition, the ad server may select advertisements from the ad database 110 and include data defining the advertisements in the provided data to the audience client device 124. The aforementioned interactions and information may be logged in data logs and such logs may be communicated to the analytics server 118 for processing. Once processed into corresponding analytics data, such data can be used as feedback to further optimize search engine results and ads, and even a sub-GUI that can extend from a search result and/or the ad on the same page view as the search result or the ad.

The advertiser client device 122 and the audience client device 124 operate as a client device when accessing information on the information system 100. A client device, such as the advertiser client device 122 and the audience client device 124 may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the foregoing devices, or the like. In the example of FIG. 1, both laptop computer 126 and smartphone 128, which can be client devices, may be operated as either an advertiser device or an audience device.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include a physical or virtual keyboard, mass storage, an accelerometer, a gyroscope, global positioning system (GPS) or other location-identifying type capability, or a display with a high degree of functionality, such as a touch-sensitive color 2D or 3D display, for example.

A client device, such as the advertiser client device 122 and the audience client device 124, may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally or remotely stored or streamed video, or video games. The foregoing is provided to illustrate that claimed subject matter is intended to include a wide range of possible features or capabilities. At least some of the features, capabilities, and interactions with the aforementioned may be logged in data logs and such logs may be communicated to the analytics server 118 for processing. Once processed into corresponding analytics data, such data can be used as feedback to further optimize search engine results and ads, and even a sub-GUI that can extend from a search result and/or the ad on the same page view as the search result or the ad.

Also, the disclosed methods and systems may be implemented at least partially in a cloud-computing environment, at least partially in a server, at least partially in a client device, or in a combination thereof.

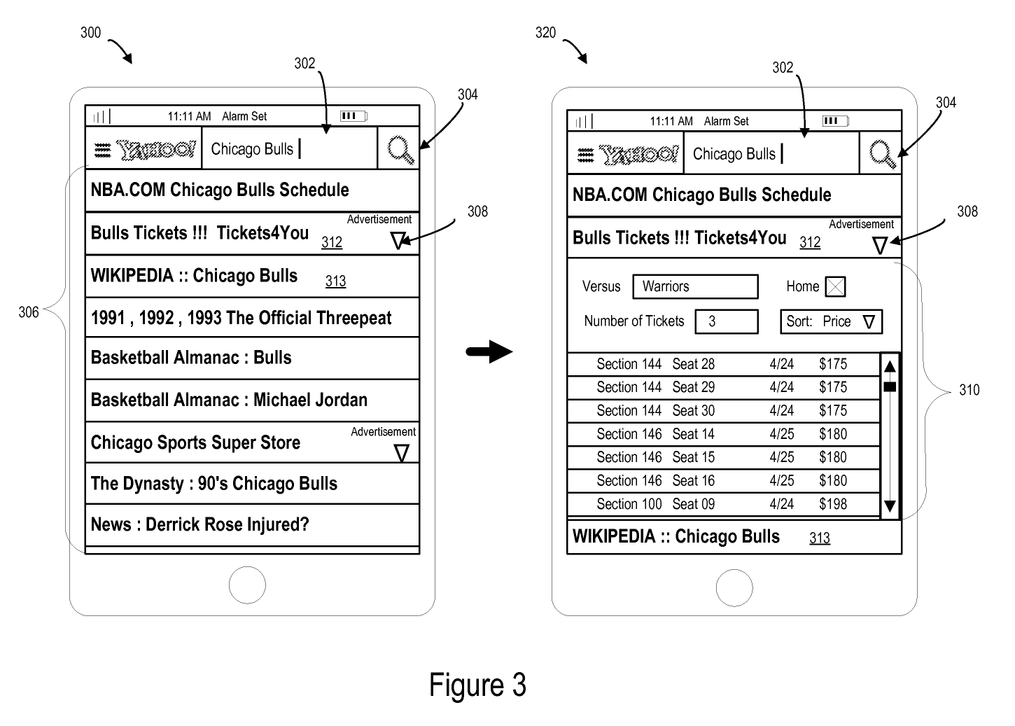

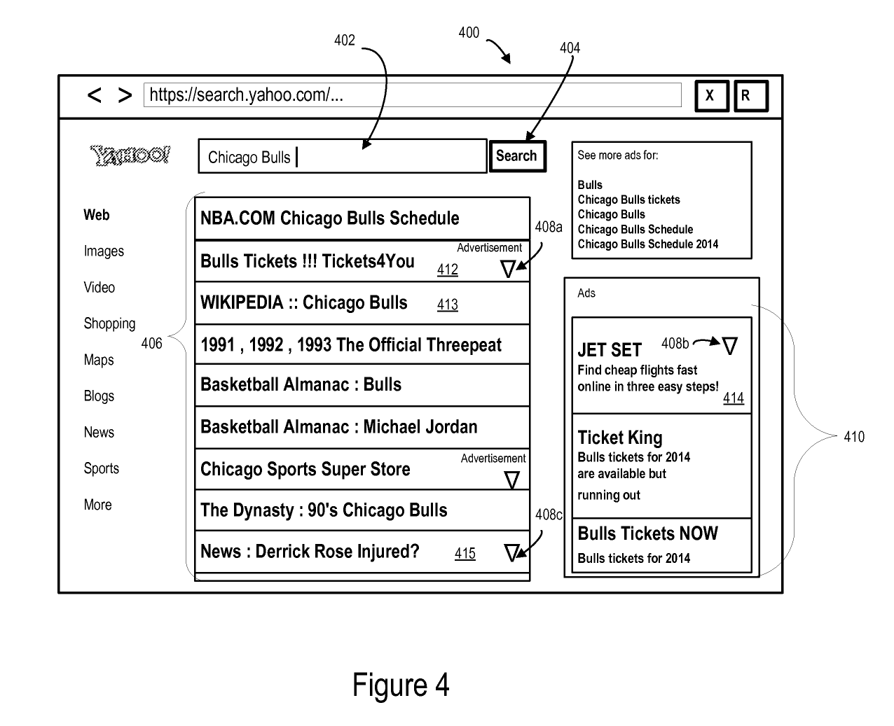

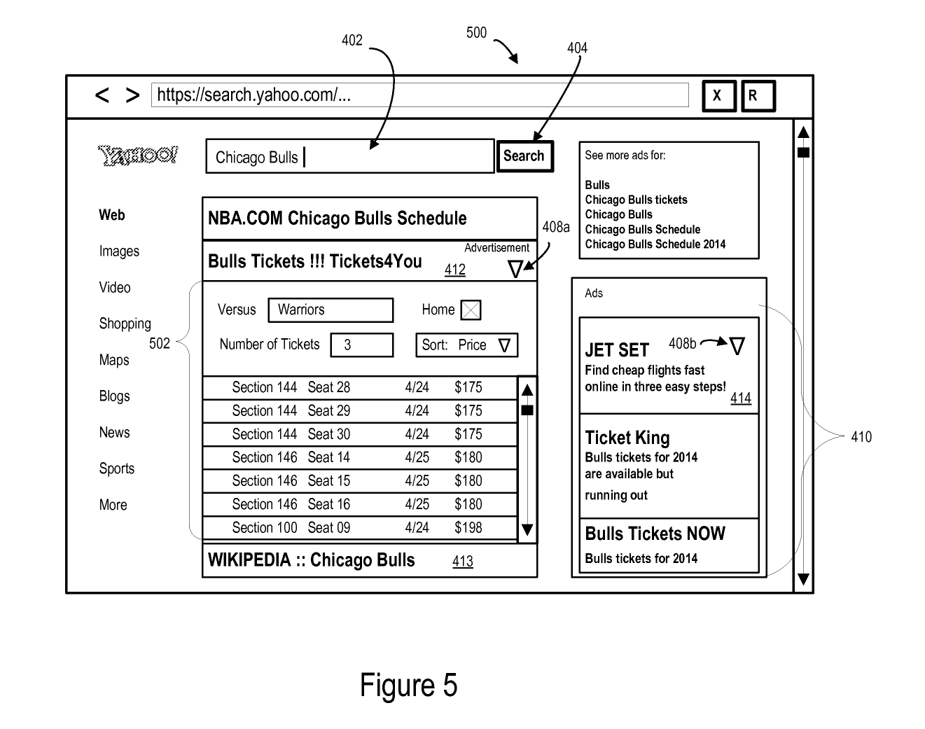

FIGS. 2-5 illustrate displayed search results including non-sponsored search results and sponsored search results. These search results are illustrated being displayed on example page views rendered by web browsers. FIGS. 2 and 3 depict mobile web browsers and FIGS. 4 and 5 depict a generic web browser that could be displayed on a displayed device of a laptop computer or a display device communicatively coupled to a desktop computer.

FIG. 2 illustrates displayed search results on a mobile device (such as the audience client device 124). Depicted are two states of the mobile device, state 200 and state 220. At state 200, the mobile device, via a display device, displays the query entry box 202 with the query string “Find me a cheap flight” entered. When a user clicks the search execution button 204, search results, such as search results 206, may appear. In the search results 206, when a user clicks on an expand search result icon (such as icon 208a) of a search result containing that icon (such as search result 212), a graphical user interface corresponding to that search result (such as sub-GUI 210) can extend out of the search result. The result of this functionality is shown in state 220. A user could also select icon 208b, for example, which can cause a respective sub-GUI to extend out of result 214. Both results to 212 and 214 are sponsored search results. In other words, these search results are monetized. Although sponsored search results are depicted with the expand search result icons in FIG. 2, any type of search result or ad could include one of these active icons; for example, expand search result icon 408b in ad 414 and expand search result icon 408c in non-sponsored search result 415 in FIG. 4. As illustrated in state 220, the sub-GUI 210 includes a form for booking tickets through a hypothetical advertiser, “Jet Set Discount Travel”. This form includes user input fields such as text boxes with one or more lines for entering text, check boxes, and a submit button.

Also in the example in FIG. 2, the sub-GUI 210 occupies the remainder of the page section below the result 212. In FIG. 3, the sub-GUI 310 does not occupy the remainder of the page section below the result 312. Actually the sub-GUI 310 occupies a space of the search results section between the search result 312 and the search result 313 in state 320.

FIG. 3 illustrates displayed search results on a mobile device (such as the audience client device 124). Depicted are two states of the mobile device, state 300 and state 320. At state 300, the mobile device, via a display device, displays the query entry box 302 with the query string “Chicago Bulls” entered. When a user clicks the search execution button 304, search results, such as search results 306, may appear. In the search results 306, when a user clicks on an expand search result icon (such as icon 308) of a search result containing that icon (such as search result 312), a graphical user interface corresponding to that search result (such as sub-GUI 310) can extend out of the search result. The result of this functionality is shown in state 320. Search result 312 is a sponsored search result. As illustrated in state 320, the sub-GUI 310 includes a form for booking basketball game tickets through a hypothetical advertiser, “Tickets4You”. This form includes user input fields such as text boxes with one or more lines for entering text, check boxes, a submit button, a drop-down list, and a scrollable list of selectable items.

FIGS. 4 and 5 illustrate displayed search results on a page view of a website displayed in a web browser. The web browser can be displayed on any type of client device that is configured to display web browsers (such as the audience client device 124). Depicted are two states of the web browser, state 400 in FIG. 4 and state 500 in FIG. 5. At state 400, the web browser, via a display device, displays the query entry box 402 with the query string “Chicago Bulls” entered. When a user clicks the search execution button 404, search results, such as search results 406, may appear. In the search results 406, when a user clicks on an expand search result icon (such as icon 408a) of a search result containing that icon (such as search result 412), a graphical user interface corresponding to that search result (such as sub-GUI 502) can extend out of the search result. In FIG. 5, the sub-GUI 502 does not occupy the remainder of the page section below the result 412. The sub-GUI 512 occupies a space of the search results section between the search result 412 and the search result 413, in state 500 of the web browser. The result of this functionality is shown in state 500 of the web browser, in FIG. 5.

As illustrated in state 500, the sub-GUI 502 includes a form for booking basketball game tickets through a hypothetical advertiser, “Tickets4You”. This form includes user input fields such as text boxes with one or more lines for entering text, check boxes, a submit button, a drop-down list, and a scrollable list of selectable items.

Also, FIGS. 4 and 5 depict an ad section 410 that include ads, such as ad 414. A sub-GUI corresponding to the advertiser of ad 414 can be extended out from the ad 414 by selecting the expand ad icon 408b. The ad section 410 can be a sponsored search section, and the ad 414 can be a sponsored search result. In FIGS. 4 and 5, search result 412 is a sponsored search result and search result 413 is not a sponsored search result. Search result 412 is identified to be a sponsored search result by the label “Advertisement”.

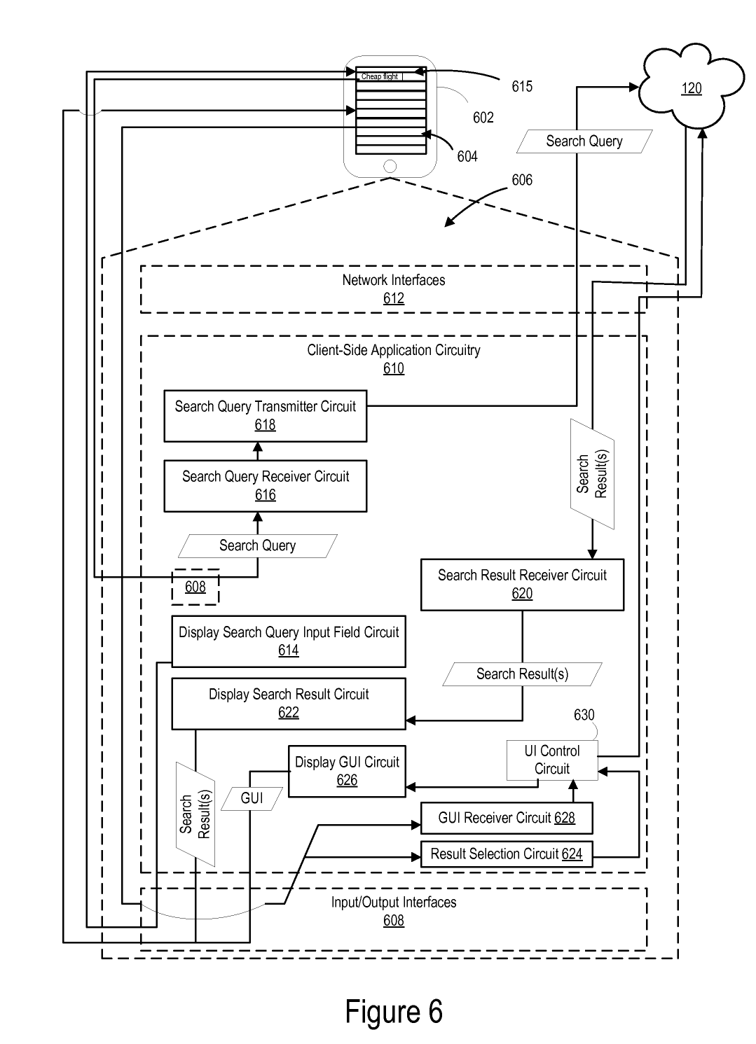

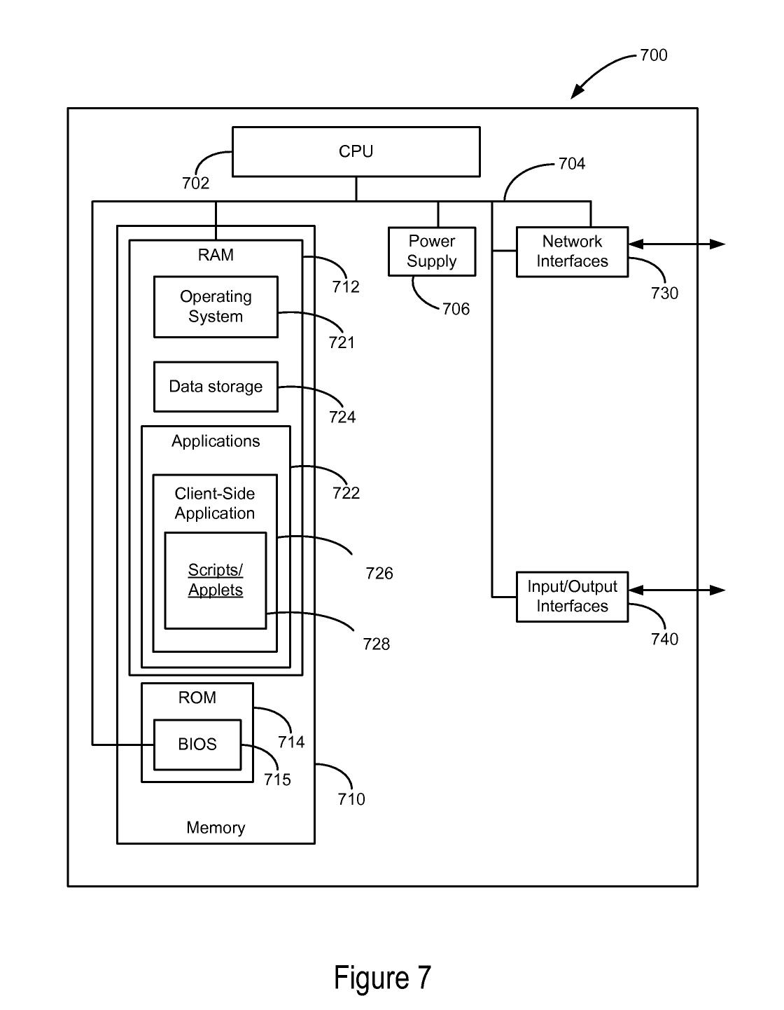

FIG. 6 illustrates a block diagram of example circuitry of a client device 602 that can provide interactive search results 604 on a page view. The circuitry 606 can be part of and/or associated with a non-transitory medium executable by a processor of the client device 602. The circuitry can include input/output interfaces 608 (such as the input/output interfaces 740 of FIG. 7). The circuitry can also include client-side application circuitry 610 (such as circuitry of the client-side application 726 of FIG. 7). The circuitry can also include network interfaces 612 (such as network interfaces 730 of FIG. 7).

The client-side application circuitry 610 can include a first circuit 616 configured to receive a search query from a search query input field of the page view. Also, the client-side application can include a circuit 614 configured to display the search query input field. The search query can be inputted by a user via the search query input field and a user input device (such as a user input device of the input/output interfaces 608). The search query can include text, an image, a voice command, a gesture (such as a gesture from a user's eye, head, torso, arm, hand, finger or any combination thereof), or any combination thereof. The receiving of the search query can occur at a placeholder within a non-transient computer readable medium, such as a reserved memory slot for that placeholder in a memory device of the client device 602. The search query can be manifested in the computer readable medium by a physical state change at the placeholder within the medium.

The client-side application circuitry 610 can also include a second circuit 618 configured to communicate the search query to a search server (such as search engine server 106 or sponsored search server 116 of FIG. 1) over a network (such as the network 120). The communicating of the search query can occur by a communications interface embedded or connected to the client device, such as a communications interface of the network interfaces 612. The communications interface can transform the changed physical state of the medium, which represents the search query, to an electromagnetic signal of any type for communications across a computer network link. The communications interface can be communicatively coupled to the non-transient computer readable medium and the search server. The search server and the client device 602 can be one or more computers connected over the network 120. The aforementioned communicative couplings and other such couplings described herein can be implemented by various types of wired and wireless connections. The communications across the couplings can be via any form of electromagnetic signal, such as an electrical signal, an optical signal, or any combination thereof. Also, in an example, the search server can be the search engine server 106, the sponsored search server 116, or any combination thereof.

The search query can be communicated with user information, wherein the user information includes demographic information associated with the user, psychographic information associated with the user, a real-time geographic location of the user, or any combination thereof. The search query can be communicated over a network that is part of a cloud computing environment. The search server can also be part of the cloud computing environment. The search server can be communicatively coupled to a content server, an ad server, an analytics server, an account server, a sponsored search server, or any combination thereof (such any one or more of the servers of FIG. 1). Any of these parts may be part of the cloud computing environment.

The client-side application circuitry 610 can also include a third circuit 620 configured to receive a search result, such as a sponsored search result, from the search server according to the search query. The receiving of the search result can occur by a communications interface embedded or connected to the client device, such as a communications interface of the network interfaces 612. The communications interface can transform an electromagnetic signal that represents the sponsored search into changed physical state of the non-transitory computer readable medium that represents the search result.

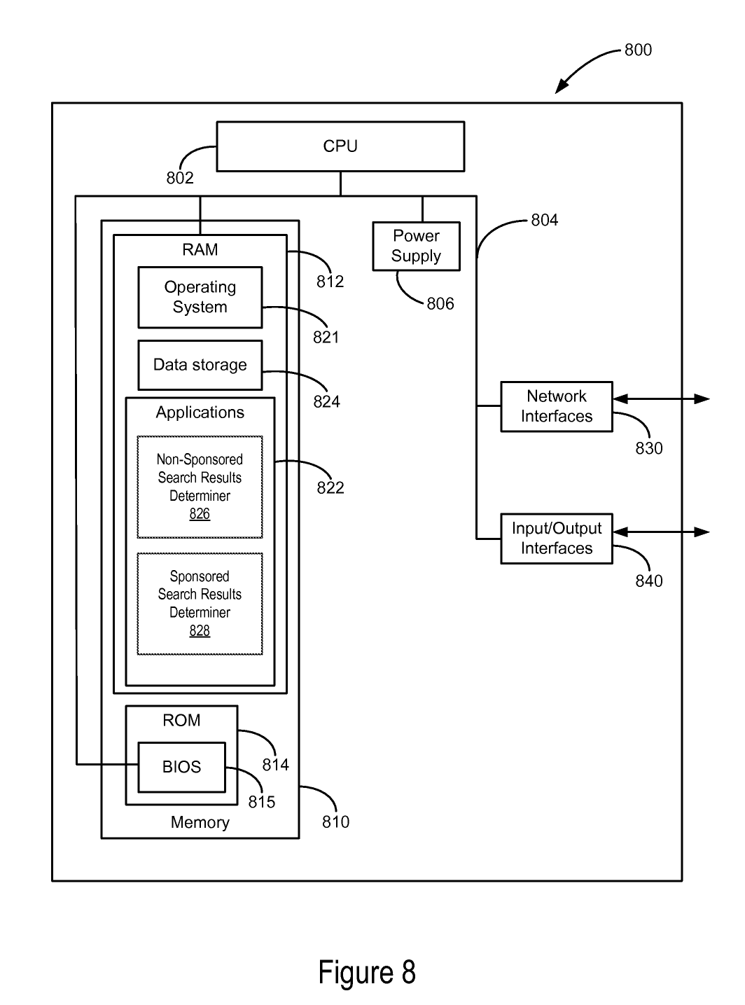

The search result can be determined at the search server according to the search query. This determination can be done by a non-sponsored search results determiner 826 and/or a sponsored search results determiner 828 of an electronic device 800 of FIG. 8. The search result can also be determined according to the user information. The search result can also be determined from data from the content server, the ad server, the analytics server, the account server, the sponsored search server, or any combination thereof (such as any one or more of the servers of FIG. 1). The search result can include instructions associated with a sub-GUI that can extend out from the search result. The instructions associated with the sub-GUI are hidden from view of the user, such as in the form of web browser readable and/or executable code.

The client-side application circuitry 610 can also include a fourth circuit 622 configured to display the search result on the page view (such as the search result 212 in FIG. 2). Where the search result is a sponsored search result, the sponsored search result can be displayed within a section of the page view dedicated to sponsored search results (such as the ad section 410 in FIGS. 4 and 5). In examples where the result is a sponsored result, the sponsored search result can also be displayed within a search results list that includes sponsored search results and non-sponsored search results (such as search results 206, 306, and 406). In such examples, the sponsored search result can be displayed first in a list of displayed search results, whether those results are sponsored or not. Also, the sponsored search result can abut a non-sponsored search result.

The displaying of the search result on a page view can occur on a display device already displaying the page view, wherein the display device is either embedded or connected to the client device 602. For examples of the results of this functionality, see results 206, 306, and 406 of FIGS. 2, 3, and 4, respectively. A graphics card or any other type of graphics processing device can transform the part of the computer readable medium representing the search result into an electromagnetic signal representing the sponsored search that can be communicated to the display device. At this point, the signal is rendered into a visual presentation by the display device. Any one of these technical functions can be implanted via an output device (such as an output device of the input/output interfaces 608).

The client-side application circuitry 610 can also include a fifth circuit 624 configured to receive a selection of a part of the search result. This section can cause the displaying of the sub-GUI as described below. The receiving of the selection can occur at a placeholder within a non-transient computer readable medium, such as a reserved memory for that placeholder in a memory device of the client device 602. The selection can be manifested in the computer readable medium by a physical state change at the placeholder within the medium. The selection can be inputted by a user via an icon selection input field and a user input device (such as a user input device of the input/output interfaces 608). The selection can occur by a user clicking on and/or moving over an expand search result icon, such as icon 208a. The selection may occur by a tactile input, a voice command, a gesture (such as a gesture from a user's eye, head, torso, arm, hand, finger or any combination thereof), or any combination thereof.

The client-side application circuitry 610 can also include a sixth circuit 626 configured to display a sub-GUI associated with the search result. The displaying of the sub-GUI occurs in the same page view and due to the selection of the part of the search result. The user interface can be proximate to the search result. The user interface can be within the same section of the search result. The user interface can abut the search result. The user interface can be immediately below the search result. The user interface can be immediately above the search result. The user interface can be immediately to a side of the search result. The user interface can be immediately kitty-corner of the search result. The user interface can be within a list of search results so that the user interface occurs below or above the search result and above or below, respectively, a search result initially below or above the search result. The search result initially below or above the search result could have been immediately below or above the search result. The displaying of the sub-GUI may cause the search result, which is immediately above or below the other search result, to move up or down according to the positioning of the sub-GUI.

The sub-GUI can present audio content, video content, textual content, graphical content, tactile content, any other type of human perceivable content, a web form, a video game, a link to a second page view, or any combination thereof. The sub-GUI can be displayed on or over the entire page view. The sub-GUI can be displayed on or over a majority of the page view. The sub-GUI can be displayed on or over a majority or the entirety of a page section containing the search result. In examples, where the sub-GUI is displayed over a part of the page view, at least part of the sub-GUI can at least be partially transparent. In other examples, the one or more parts besides the user interface can be suppressed visually when the sub-GUI is displayed. The visual suppression can include blurring, reduction in size, reduction in brightness, reduction in sharpness, pixelization, filtering out one or more colors, or any combination thereof.

Examples of sub-GUIs are shown in FIGS. 2, 3, and 5 (see sub-GUIs 210, 310, and 502). A graphics card or any other type of graphics processing device can transform the part of the computer readable medium representing the sub-GUI into an electromagnetic signal representing the sub-GUI that can be communicated to the display device. At this point, the signal is rendered into a visual presentation by the display device. Any one of these technical functions can be implanted via an output device (such as an output device of the input/output interfaces 608).

The client-side application circuitry 610 can also include a seventh circuit 628 configured to receive a user input from a user input field of the sub-GUI. The receiving of the user input from the user input field of the sub-GUI can occur at a placeholder within a non-transient computer readable medium. Also, the receiving of the user input or any other receiving of user input described herein can occur via various known ways of receiving user input, such as the ways described herein. For example, the user input for the sub-GUI can be received and processed via a user input device (such as a user input device of the input/output interfaces 608). The user input can include text, an image, a voice command, a gesture (such as a gesture from a user's eye, head, torso, arm, hand, finger or any combination thereof), or any combination thereof.

The user input field can include a text box with one or more lines for entering text, a check box, radio button, a file select control for uploading a file, a reset button, a submit button, a drop-down list, a scrollable list, or any combination thereof. The user input field can also include a selectable image, an animated image, a fixed image, or any combination thereof. The user input field can be presented according to the search query, demographic information associated with the user, psychographic information associated with the user, a real-time geographic location of the user, or any combination thereof.

The client-side application circuitry 610 can also include an eighth circuit 630 configured to initiate an action according to the received user input from the user input field of the sub-GUI. The action can be manifested by one or more computer parts described herein, network parts described herein, any other known computer hardware, any other known computer software, and any combination thereof. For example, an action that occurs usually on the client-side can be implemented by a part of the client device 602. An action that occurs usually on the server-side can be implemented by a part of one of the servers described herein, such as the servers described with respect to FIG. 1.

The action can include displaying one or more sub-GUIs (such as the sub-GUI), audio content, video content, textual content, graphical content, tactile content, any other type of human perceivable content, a second web form, a second user input field, a link to a second page view, a change to a state of the user input field (such as a location of the field, a size of the field, coloring of the field, brightness of the field, shape of the field, or another type of graphical makeup of the field, or any combination thereof), or any combination thereof. The action can include submission of the user input to a server. Such a submission can be used towards a transaction. The submission can be stored in a database. Also, the submission can be used to determine at least part of the displaying of the user interface (in other words, the submission can be used as feedback).

FIG. 7 is a block diagram of an example electronic device 700 that can implement client-side aspects of and related to example systems that can provide interactive search results. For example, the electronic device 700 can be the audience client device 124. The electronic device 700 can include a central processing unit (CPU) 702, memory 710, a power supply 706, and input/output components, such as network interfaces 730 and input/output interfaces 740, and a communication bus 704 that connects the aforementioned elements of the electronic device. The network interfaces 730 can include a receiver and a transmitter (or a transceiver), and an antenna for wireless communications. The CPU 702 can be any type of data processing device, such as a central processing unit (CPU). Also, for example, the CPU 702 can be central processing logic; central processing logic may include hardware (such as circuits and/or microprocessors), firmware, software and/or combinations of each to perform functions or actions, and/or to cause a function or action from another component. Also, central processing logic may include a software controlled microprocessor, discrete logic such as an application specific integrated circuit (ASIC), a programmable/programmed logic device, memory device containing instructions, or the like, or combinational logic embodied in hardware. Also, logic may also be fully embodied as software.

The memory 710, which can include random access memory (RAM) 712 or read-only memory (ROM) 714, can be enabled by memory devices, such as a primary (directly accessible by the CPU) and/or a secondary (indirectly accessible by the CPU) storage device (such as flash memory, magnetic disk, optical disk).

The RAM 712 can store data and instructions defining an operating system 721, data storage 724, and applications 722, including the client-side application 726 and the scripts and/or applets 728. The applications 722 may include hardware (such as circuits and/or microprocessors), firmware, software, or any combination thereof. Example content provided by an application, such as the client-side application 726, may include text, images, audio, video, or the like, which may be processed in the form of physical signals, such as electrical signals, for example, or may be stored in memory, as physical states, for example.

The ROM 714 can include basic input/output system (BIOS) 715 of the electronic device 700. The power supply 706 contains power components, and facilitates supply and management of power to the electronic device 700. The input/output components can include various types of interfaces for facilitating communication between components of the electronic device 700, components of external devices (such as components of other devices of the information system 100), and end users. For example, such components can include a network card that is an integration of a receiver, a transmitter, and I/O interfaces, such as input/output interfaces 740. A network card, for example, can facilitate wired or wireless communication with other devices of a network. In cases of wireless communication, an antenna can facilitate such communication. The I/O components, such as I/O interfaces 740, can include user interfaces such as monitors, keyboards, touchscreens, microphones, and speakers. Further, some of the I/O components, such as I/O interfaces 740, and the bus 704 can facilitate communication between components of the electronic device 700, and can ease processing performed by the CPU 702.

FIG. 8 is a block diagram of an example electronic device 800 that can implement server-side aspects of and related to example systems that can provide interactive search results. For example, the electronic device 800 can be a device that can implement the search engine server 106 and/or the sponsored search server 116 of FIG. 1. The electronic device 800 can include a CPU 802, memory 810, a power supply 806, and input/output components, such as network interfaces 830 and input/output interfaces 840, and a communication bus 804 that connects the aforementioned elements of the electronic device. The network interfaces 830 can include a receiver and a transmitter (or a transceiver), and an antenna for wireless communications. The CPU 802 can be any type of data processing device, such as a central processing unit (CPU). Also, for example, the CPU 802 can be central processing logic.

The memory 810, which can include random access memory (RAM) 812 or read-only memory (ROM) 814, can be enabled by memory devices. The RAM 812 can store data and instructions defining an operating system 821, data storage 824, and applications 822. The applications 822 can include a non-sponsored search results determiner 826 and a sponsored search results determiner 828. The applications 822 may include hardware (such as circuits and/or microprocessors), firmware, software, or any combination thereof. The ROM 814 can include basic input/output system (BIOS) 815 of the electronic device 800.

The power supply 806 contains power components, and facilitates supply and management of power to the electronic device 800. The input/output components can include the interfaces for facilitating communication between any components of the electronic device 800, components of external devices (such as components of other devices of the information system 100), and end users. For example, such components can include a network card that is an integration of a receiver, a transmitter, and I/O interfaces, such as input/output interfaces 840. The I/O components, such as I/O interfaces 840, can include user interfaces such as monitors, keyboards, touchscreens, microphones, and speakers. Further, some of the I/O components, such as I/O interfaces 840, and the bus 804 can facilitate communication between components of the electronic device 800, and can ease processing performed by the CPU 802.

The electronic device can include a computing device that is capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

1. A system stored in a non-transitory medium executable by a processor, comprising:
a first circuit configured to display a search result on a page view of a client-side application;
a second circuit configured to receive a selection of a part of the search result;
a third circuit configured to display a graphical user interface (GUI) associated with the search result, the displaying of the GUI occurring in the page view and due to the selection of the part of the search result;
a fourth circuit configured to receive a user input from a user input field associated with the GUI; and
a fifth circuit configured to initiate an action according to the user input.

2. The system of claim 1, wherein the search result is a sponsored search result.

3. The system of claim 1, further comprising:
a sixth circuit configured to receive a search query from a search field;
a seventh circuit configured to communicate the search query to a search server; and
an eighth circuit configured to receive the search result from the search server according to the search query.

4. The system of claim 3, wherein the search query can be communicated with user demographic information, and wherein the search result is determined according to at least part of the demographic information.

5. The system of claim 3, wherein the search query can be communicated with user psychographic information, and wherein the search result is determined according to at least part of the psychographic information.

6. The system of claim 3, wherein the search query can be communicated with real-time geographic location of a user that submitted the search query, and wherein the search result is determined according to the real-time geographic location of the user.

7. The system of claim 1, wherein the displaying of the GUI shares a boundary with the search result.

8. The system of claim 1, wherein the displaying of the GUI is within a same section of the page view as the search result.

9. The system of claim 1, wherein the displaying of the GUI is immediately below the search result.

10. The system of claim 9, wherein the displaying of the GUI causes a next search result immediately below the search result to move downwards.

11. The system of claim 1, wherein the displaying of the GUI encompasses at least a majority of the page view.

12. The system of claim 1, wherein the GUI includes a web form.

13. The system of claim 1, wherein the GUI includes a video game.

14. The system of claim 1, wherein the page view is a first page view, and wherein the GUI includes a link to a second page view.

15. The system of claim 1, wherein the GUI includes audio content, video content, or any combination thereof.

16. The system of claim 1, wherein the displaying of the search result is within a list of search results, and wherein the list of search results includes a sponsored search result and a non-sponsored search result.

17. The system of claim 1, further comprising a sixth circuit to visually suppress graphical elements of the page view besides the GUI, the search result, or any combination thereof.

18. A method, comprising:
receiving, at a first circuit, a search query from a search field on a page view;
communicating, by a second circuit communicatively coupled to the first circuit, the search query to a search server, the communication occurring over a network link;
receiving, at a third circuit, a search result from the search server according to the search query.
displaying, by a display device communicatively coupled to the third circuit, the search result on the page view;
receiving, at a fourth circuit communicatively coupled to the display device, a selection of a part of the search result;
displaying, by the display device, a sub graphical user interface (sub-GUI) associated with the search result, the displaying of the GUI occurring in the page view and due to the selection of the part of the search result; and
receiving, at a fifth circuit communicatively coupled to the display device, a user input from a user input field associated with the GUI.

19. The method of claim 18, further comprising: initiating, at a sixth circuit communicatively coupled to the fifth circuit, an action according to the user input.

20. A system, comprising:
a means for displaying a search result on a page view;
a means for receiving a selection of a part of the search result;
a means for displaying a graphical user interface (GUI) associated with the search result, the displaying of the GUI occurring in the page view and according to the selected part of the search result; and
a means for receiving a user input from a user input field associated with the GUI.
